(19) United States
(12) Patent Application Publication
(10) Pub. No.: US 2025/0084984 A1
(43) Pub. Date: Mar. 13, 2025

(54) SNAP FIT OPTICAL DEVICE FOR A LIGHTING DEVICE

(71) Applicant: SIGNIFY HOLDING B.V., EINDHOVEN (NL)

(72) Inventor: TIMOTHY GLENN WRIGHT, PEACHTREE CITY, GA (US)

(21) Appl. No.: 18/826,269

(22) Filed: Sep. 6, 2024

Related U.S. Application Data
(60) Provisional application No. 63/536,955, filed on Sep. 7, 2023.

(30) Foreign Application Priority Data
Sep. 14, 2023 (EP) 23197380.1

(51) Int. Cl. F21V 17/16; F21V 17/12; F21Y 115/10

(52) U.S. Cl. CPC F21V 17/164; F21V 17/12; F21Y 2115/10

(57) ABSTRACT

An optical device includes a body having one or more apertures located therein configured to detachably couple the body to a surface of a lighting device. The lighting device has one or more attachment elements on the surface. The attachment elements each have a sleeve extending from the surface and a head. The one or more sleeves each have a sleeve diameter smaller than a head diameter of the head, each of the one or more apertures have a flange having a flange diameter smaller than the head diameter of the head portion such that the flange is configured to be located at least partially around the sleeve and below the head when the optical device is detachably coupled to the surface of the lighting device.

### CROSS-REFERENCE TO PRIOR APPLICATIONS

This application claims the benefit of both European Patent Application No. 23197380.1, filed on Sep. 14, 2023 and U.S. Provisional Application No. 63/536,955, filed on Sep. 7, 2023. These applications are hereby incorporated by reference herein.

### FIELD OF THE INVENTION

The present disclosure is generally directed to a snap fit optical device for a lighting device, such as a lighting square, and more specifically, an optical device that can be snap fit mounted to a lighting square without the use of any tools.

### BACKGROUND OF THE INVENTION

Lighting squares are used in a number of lighting applications, such as decorative streetlights, by way of example. The lighting squares often include a printed circuit board having a plurality of light emitting diodes with a lens located over the light emitting diodes to direct or control the light output. The lens may be attached to other elements in the lighting square, such as a heat sink, by a set of screws. In some applications, the end-user may apply an optical device, such as a shield, visor, beauty ring, or a supplemental lens, by way of example, to provide additional mechanical control of the light generated or to change the aesthetic appearance of the lighting square. While such optical devices are available, mounting them on the lighting square often requires loosening or removing the screws that attach the lens to the lighting square. The screws often provide thermal contact to the heat sink. As a result, loosening the screws weakens the thermal contact. Additionally, failure to tighten the screws after installation of the optical device can cause failures due to improper heat sinking.

Accordingly, there is a need in the art for an optical device and lighting system including the optical device that allow for easy, toolless installation of the optical device on a lighting device in the field without the need to remove or loosen any screws.

### SUMMARY OF THE INVENTION

The present disclosure is directed a lighting system. The lighting system includes a lighting device, such as a lighting square having a plurality of light emitting diodes located on a printed circuit board. The lighting device further includes a lens that provides a surface having one or more sleeves extending from a surface thereof for receiving a screw therein for coupling the lens to other elements of the lighting device, such as the printed circuit board and a heat sink. The one or more sleeves provide a sleeve diameter smaller than a head diameter of the head of the screw. The lighting system further includes an optical device, such as a shield, visor, beauty ring, or additional lens. The optical device includes a body having one or more apertures located therein configured to detachably couple the body to the surface of the lighting device. Each of the one or more apertures have a flange. The flange has a flange diameter smaller than the head diameter of the head of the screw such that it is configured to be located at least partially around the sleeve and below the head of the screw when the optical device is detachably coupled to the surface of the lighting device.

The optical device can advantageously be mounted on the lighting device using a snap fit over the screws located on the lighting device. The optical device can be installed in the field without the use of any tools and without needing to loosen or remove the screws. The optical device can be installed to control the light output by the lighting device or to alter the aesthetic appearance of the lighting device.

Generally, in one aspect, an optical device is provided. The optical device includes a body having one or more apertures located therein configured to detachably couple the body to a surface of a lighting device.

The lighting device has one or more attachment elements on the surface. The attachment elements each have a sleeve extending from the surface and a head. The one or more sleeves each have a sleeve diameter smaller than a head diameter of the head.

Each of the one or more apertures has a flange. The flange has a flange diameter smaller than the head diameter of the head such that it is configured to be located at least partially around the sleeve and below the head when the optical device is detachably coupled to the surface of the lighting device.

According to an example, the flange is flexible to allow the one or more apertures to be snap fit over the head.

According to an example, the one or more sleeves are configured to receive a screw therein. The screw provides the head. The optical device is detachably coupled to the surface of the lighting device without removing the screw.

According to an example, the optical device is a shield, a lens, a beauty ring, or a visor.

According to an example, the optical device is formed from a polycarbon.

According to an example, the body comprises a plurality of the one or more apertures.

According to an example, the body comprises one or more optical elements located thereon.

According to an example, the lighting device is a lighting square having a plurality of light emitting diodes.

Generally, in another aspect, a lighting system is provided. The lighting system includes a lighting device comprising one or more attachment elements on the surface. The attachment elements each have a sleeve extending from the surface and a head. The one or more sleeves each have a sleeve diameter smaller than a head diameter of the head. The lighting device has a plurality of light emitting diodes.

The lighting system further includes an optical device. The optical device includes a body having one or more apertures located therein configured to detachably couple the body to the surface of the lighting device. Each of the one or more apertures have a flange. The flange has a flange diameter smaller than the head diameter of the head such that it is configured to be located at least partially around the sleeve and below the head when the optical device is detachably coupled to the surface of the lighting device.

According to an example, the flange is flexible to allow the one or more apertures to be snap fit over the head.

According to an example, the one or more sleeves are configured to receive a screw therein. The screw provides the head. The optical device is detachably coupled to the surface of the lighting device without removing the screw.

According to an example, the optical device is a shield, a lens, a beauty ring, or a visor.

According to an example, the body comprises one or more optical elements located thereon.

According to an example, the lighting device is a lighting square having a plurality of light emitting diodes.

According to an example, the body comprises one or more optical elements located thereon configured to interact with one or more of the plurality of the light emitting diodes.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an isometric view of an exemplary light system including a lighting device having an exemplary optical device installed thereon, according to aspects of the present disclosure.

FIG. 2 is an isometric view of the lighting device shown in FIG. 1, with the optical device removed, according to aspects of the present disclosure.

FIG. 3 is an isometric view of the lighting device shown in FIG. 2 with the screws removed for illustration purposes, according to aspects of the present disclosure.

FIG. 4A is a side close-up view of one of the sleeves of the lighting device with the screw removed as shown in FIG. 3, according to aspects of the present disclosure.

FIG. 4B is a side close-up view of one of the screws located in a sleeve of the lighting device as shown in FIG. 2, according to aspects of the present disclosure.

FIG. 5 is an isometric view of an exemplary printed circuit board of the lighting device shown in in FIG. 2, according to aspects of the present disclosure.

FIG. 6 is an isometric view of the optical device shown in FIG. 1, according to aspects of the present disclosure.

FIG. 7 is a top view of the optical device shown in FIG. 1, according to aspects of the present disclosure.

FIG. 8 is an isometric view of another exemplary lighting system with the lighting device having a set of exemplary optical devices installed thereon, according to aspects of the present disclosure.

FIG. 9 is an isometric view of the lighting system shown in FIG. 9 with three of the optical devices, which are perimeter shields, removed to illustrate the attachment of one of the set of optical devices, according to aspects of the present disclosure.

FIG. 10 is an isometric view of the optical device shown in FIG. 9, according to aspects of the present disclosure.

### DETAILED DESCRIPTION OF THE EMBODIMENTS

The present disclosure is directed a lighting system. The lighting system includes a lighting device, such as a lighting square having a plurality of light emitting diodes located on a printed circuit board. The lighting device further includes a lens that provides a surface having one or more sleeves extending from a surface thereof for receiving a screw therein for coupling the lens to other elements of the lighting device, such as the printed circuit board and a heat sink. The one or more sleeves provide a sleeve diameter smaller than a head diameter of the head of the screw. The lighting system further includes an optical device, such as a shield, visor, beauty ring, or additional lens. The optical device includes a body having one or more apertures located therein configured to detachably couple the body to the surface of the lighting device. Each of the one or more apertures have a flange. The flange has a flange diameter smaller than the head diameter of the head of the screw such that it is configured to be located at least partially around the sleeve and below the head of the screw when the optical device is detachably coupled to the surface of the lighting device.

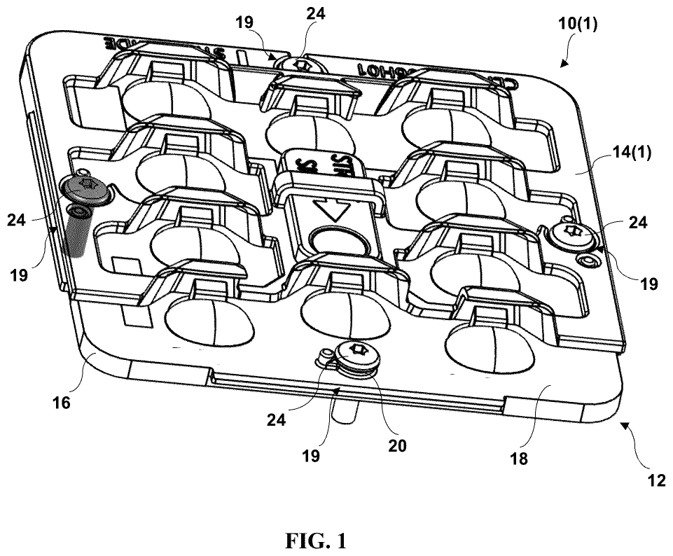

FIG. 1 is an isometric view of an exemplary lighting system 10(1) including a lighting device 12 an optical device 14(1) installed thereon. The optical device 14(1) is advantageously snap fit onto the lighting device 12, which allows for easy toolless installation, as described in further detail herein. In this example, the optical device 14(1) is a house side shield, although the optical device can be various types and/or numbers of optical devices, such as shields, visors, lenses, or beauty rings, by way of example only, although the optical device 14(1) can be any device to be installed on the lighting device 12 to control the output light emitted by the lighting device 12 or to change the aesthetic appearance of the lighting device 12. It is to be understood that various types of optical devices can be employed that allow for snap fit installation on the lighting device 12, as described herein.

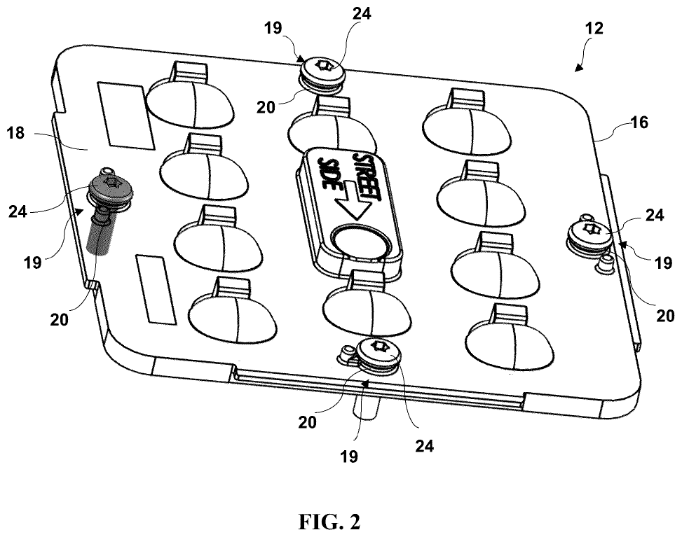

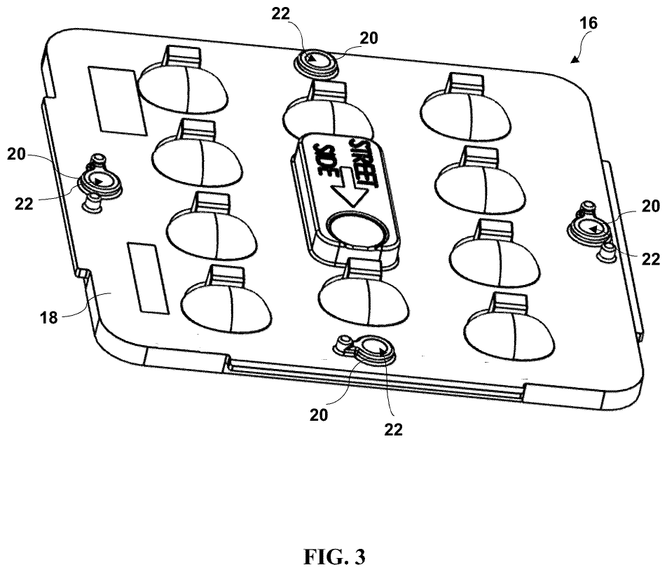

FIGS. 2 and 3 are isometric views of the lighting device 12 shown in FIG. 1 with the optical device 14(1) removed. In this example, the lighting device 12 is a lighting square for a light fixture, although the optical device 14(1) could be employed with other types of lighting devices in other configurations. The lighting device 12 includes a lens 16 having a surface 18 that forms the upper surface (as oriented in FIG. 2) of the lighting device 12. Although the lens 16 provides the surface 18, it is to be understood that the optical device 14(1) (FIG. 1) could be installed on other surfaces that provide an upper surface of the lighting device 12. In this example, the lens 16 is an injection molded plastic lens, although other types of lenses formed of other materials may be employed in the lighting device 12. The lens 16 can have various configurations located on the surface 18 to control the output light from the lighting device 12.

The lens 16 includes attachment elements 19. In this example, the attachment elements 19 include sleeves 20 extending from the surface 18. In one example, the attachment element 19 can further include a head that is molded as part of the plastic of the lens 16. In other examples, as shown in FIGS. 2 and 3, the sleeves 20 have an aperture 22 located therein for receiving screws 24 (as shown in FIG. 2), although other attachment mechanisms, such as rivets, nuts, or drive pins could be employed. The screws 24 couple the lens 16 to other elements of the lighting device 12 as described herein. In some examples, the screws 24 may also contact a heat sink when installed to provide thermal contact between the screws 24 and the heat sink (not shown). In this example, the lens 16 includes four sleeves 20 for receiving four screws 24, although other numbers of sleeves can be employed in other configurations for receiving other numbers of screws.

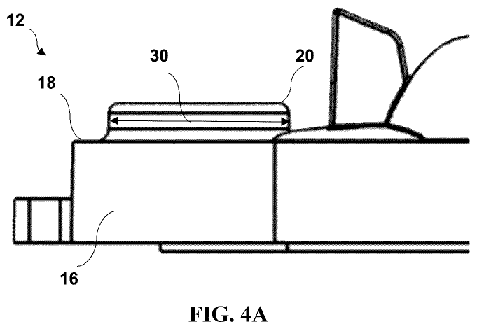

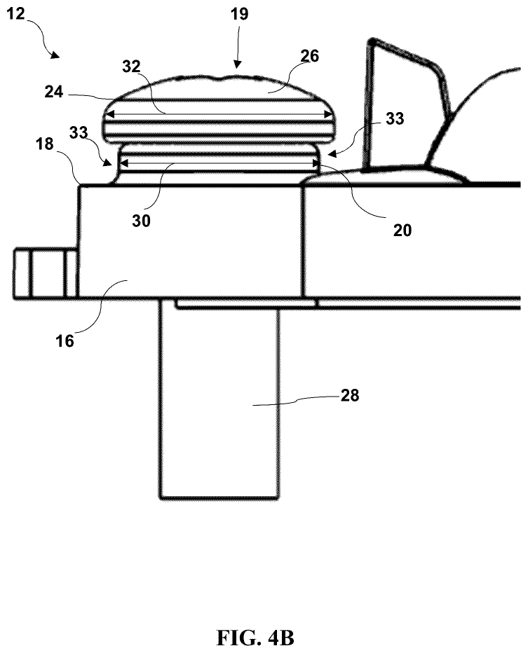

FIGS. 4A and 4B are close-up side views of one of the sleeves 20 with the screw 24 removed (FIG. 4A) and with the screw 24 installed in the sleeve 20 (FIG. 4B). As shown in FIG. 4B, the screw 24 includes a head 26 that rests on top of sleeve 20 when installed and a shaft that extends through the sleeve 20 to couple the lens 16 to other portions of the lighting device 12. For example, the shaft 28 may be in thermal contact with a heat sink (not shown) when the lighting device 12 is installed. Referring again to FIGS. 4A and 4B, the sleeves 20 have a sleeve diameter 30. The sleeve diameter is smaller in relation to a head diameter 32 of the head 26 of the screw 24, as shown in FIG. 4B. As such, the underside of the head 26 of the screw 24 abuts the top of the sleeve 20 when installed and has portions that overhang the sleeve 20 to form overhang areas 33 on each side of the sleeve 20. The overhang areas 33 are utilized to install an optical device on the screws 24, such as the optical device 14(1) shown in FIG. 1, in a snap fit manner without the need for any tools or loosening the screws 24, as described herein.

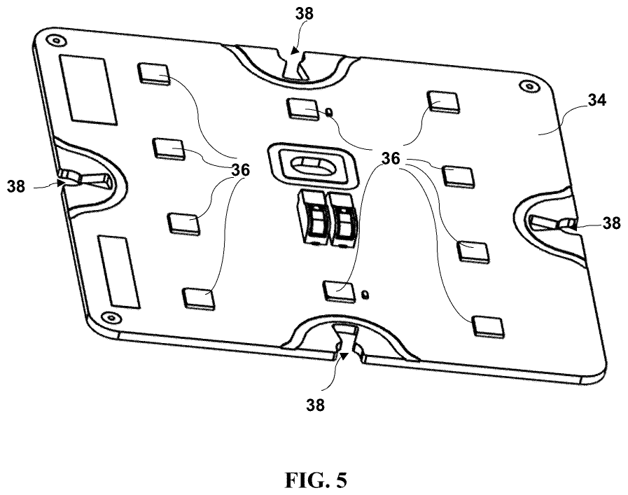

FIG. 5 is an isometric view of a printed circuit board 34 of the lighting device 12 shown in in FIG. 2. The printed circuit board 34 includes a plurality of light emitting diodes 36 located thereon. The lens 16 is located over the printed circuit board 34 such that the surface 18 of the lens 16 can control the light output from the plurality of light emitting diodes 36. The light emitting diodes 36 are positioned on the printed circuit board 34 to interact with the lens 16 when the lens 16 is installed thereon. The printed circuit board has apertures 38 located along the edges thereof to receive the shaft 28 of the screws 24 therethrough to couple the lens 16 to the printed circuit board 34.

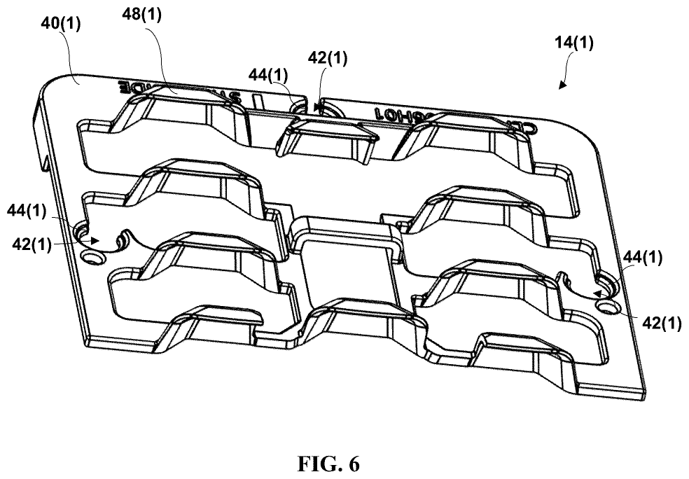

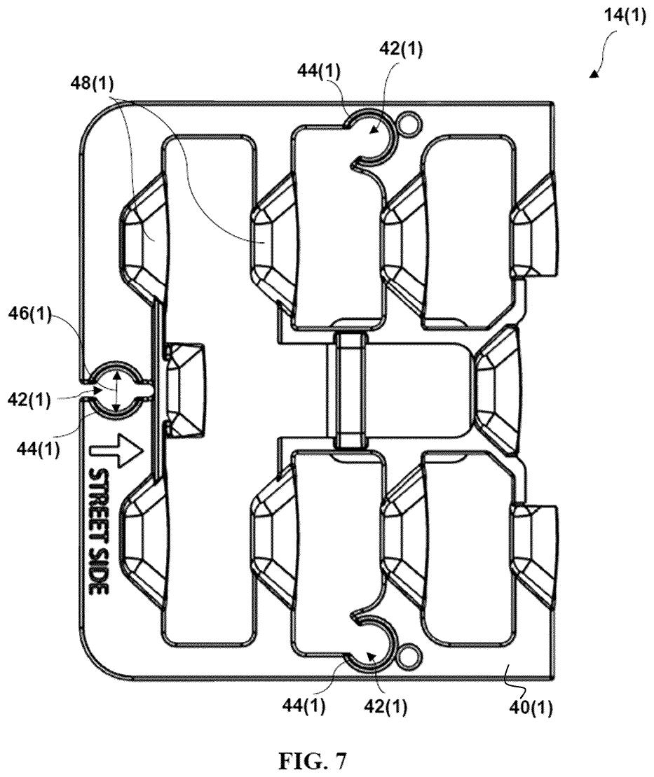

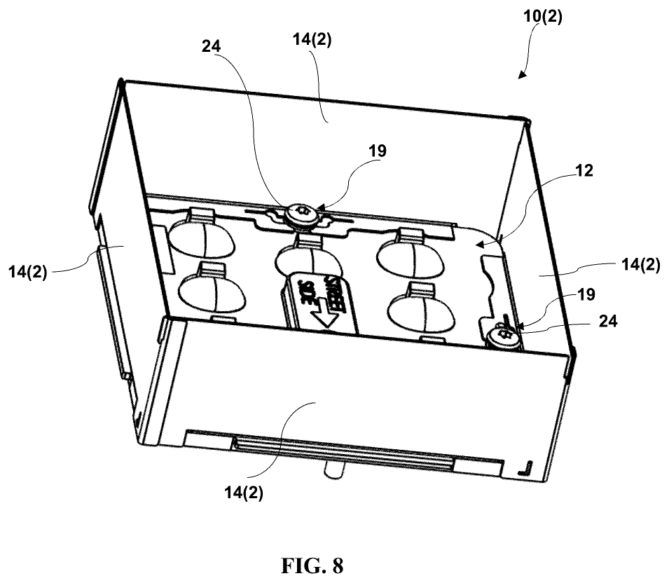

FIGS. 6 and 7 are an isometric view and top view of the optical device 14(1) of the lighting system 10(1) shown in FIG. 1, respectively. In this example, the optical device 14(1) is a house side shield that can be snap fit installed onto the lighting device 12, although other optical devices can be employed with the lighting device 12, such as the lighting device 14(2) of the lighting system 10(2) shown in FIGS. 8-10. It is to be understood that the present technology can be employed with various types of optical devices to provide toolless installation on the lighting device 12. For example, the present technology can be used to provide a shield, a lens, a beauty ring, or a visor for the lighting device 12, although the optical device can be other elements configured to control the light output by the lighting device 12 or to alter the aesthetic appearance of the lighting device 12.

The optical device 14(1) is configured to be detachably coupled to the surface 18 of the lighting device 12 provided by the lens 16 without removing the screws 24, as described herein. In this example, the optical device 14(1) includes a body 40(1) having apertures 42(1) located therein. The body 40(1) for example can be an injection molded structure formed from a flexible material, such as a polycarbon, by way of example only, although other flexible materials with suitable optical properties can be employed for the body 40(1).

The apertures 42(1) are configured to detachably couple the body 40(1) of the optical device 14(1) to the surface 18 of the lens 16 of the lighting device 12. In this example, the optical device 14(1) includes three apertures 42(1) located at the edges to match up with the location of three of the screws 24 of the lighting device 12, although the optical device 14(1) can have any other numbers and configurations of apertures 42(1) to match the location of the screws 24 on the lighting device 12 for toolless installation in accordance with the present disclosure.

Referring again to FIGS. 6 and 7, each of the apertures 42(1) has a flange 44(1) located therein. In this example, the flanges 44(1) are located inside the apertures 42(1), which have a semi-circular profile. As shown in FIG. 7, the flanges 44(1) each have a flange diameter 46(1) that is smaller than the head diameter 32 of the head 26 of the screw 24 (as shown in FIG. 4B). In this manner, the apertures 42(1) are configured to be located at least partially around the sleeve 20 with the flange 44(1) positioned in the overhang areas 33 below the head 26 of the screw 24 when the optical device 14(1) is detachably coupled to the surface 18 of the lighting device 12.

The flanges 44(1) are flexible to allow the apertures 42(1) to be snap fit over the head 26 of the screw 24. For example, the body 40(1) may be formed of a flexible material, such as a polycarbon, by way of example only. During installation of the optical device 14(1) on the lighting device 12, the apertures 42(1) of the body 40(1) of the optical device 14(1) are aligned with the screws 24 on the lighting device 12. The flange diameter 46(1) is smaller than the head diameter 32 of the head 26 of the screw 24. In this manner, when the flanges 44(1) are pressed against the head of the screw 24, each of the flanges 44(1) must flex inward to allow the head 26 of the screw 24 to access the aperture 42(1). Once the flange 44(1) is passed over the head 26 of the screw 24, the flange 44(1) can flex back into its natural position and is located in the overhang areas 33 below the head 26 of the screw 24 to hold the optical device 14(1) in position on the lighting device 12, as shown in FIG. 1.

Referring again to FIGS. 6 and 7, the body 40(1) further includes optical elements 48(1) located thereon. The optical elements 48(1) can be located on the body 14(1) to interact with the light emitting diodes 36 located on the printed circuit board 34 (FIG. 5) to control the light emitted therefrom. In this example, the optical elements 48(1) are configured to serve as a house side shield to substantially block light emitted from the light emitting diodes 36 of the lighting device 12 in one direction, although other optical elements, such as lenses may be employed on the body 40(1) of the optical device 14(1).

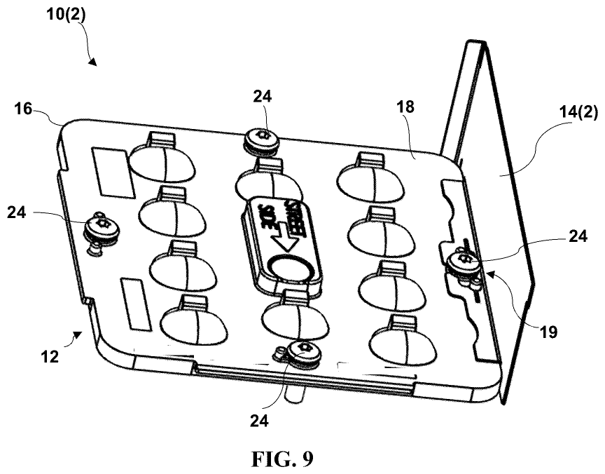

FIGS. 8 and 9 are isometric views of another exemplary lighting system 10(2) including the lighting device 12 having a plurality of optical devices 14(2) installed thereon. The optical devices 14(2) are advantageously snap fit onto the lighting device 12, which allows for easy toolless installation, in similar fashion as described above with respect to the optical device 14(1). In this example, the optical device 14(2) are perimeter shields that can be installed around the outer perimeter of the lighting device 12 using the screws 24 of the lighting device 12 without removing or loosening the screws 24. FIG. 9 is an isometric view of the lighting system 10(2) with the single optical device 14(2) installed thereon.

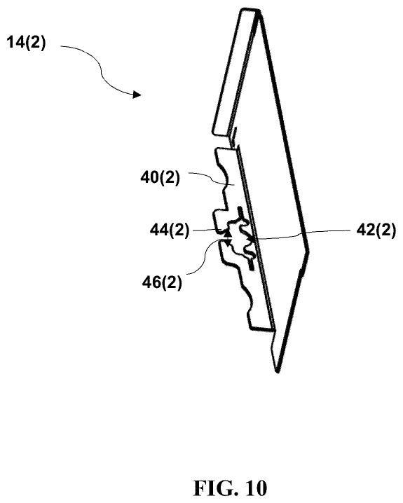

FIG. 10 is an isometric view of the optical device 14(2). The optical device 14(2) is configured to be detachably coupled to the surface 18 of the lighting device 12 provided by the lens 16 without removing the screws 24, as described herein. In this example, the optical device 14(2) includes a body 40(2) having an aperture 42(1) located therein. The body 40(1) for example can be formed from a flexible material.

The aperture 42(2) is configured to detachably couple the body 40(2) of the optical device 14(1), which in this example is a perimeter shield, to the surface 18 of the lens 16 of the lighting device 12. In this example, the aperture 42(2) configured to match up with the location of the screws 24 of the lighting device 12 to position the perimeter shield at the perimeter of the lighting device 12, although the optical device 14(2) can have any other numbers and configurations of apertures 42(2) to match the location of the screws 24 on the lighting device 12 for toolless installation in accordance with the present disclosure.

Referring again to FIG. 10, the apertures 42(2) has a flange 44(2). In this example, the flange 44(2) is located along an edge of the apertures 42(2). The flange 44(2) provides a flange diameter 46(2) that is smaller than the head diameter 32 of the head 26 of the screw 24 (as shown in FIG. 4B). In this manner, the aperture 42(2) is configured to be located at least partially around the sleeve 20 with the flange 44(2) located in the overhang areas 33 below the head 26 of the screw 24 when the optical device 14(2) is detachably coupled to the surface 18 of the lighting device 12.

The flange 44(2) is flexible to allow the aperture 42(2) to be snap fit over the head 26 of the screw 24. For example, the body 40(2) may be formed of a flexible material such that the flange 44(2) is also flexible. During installation of the optical device 14(2) on the lighting device 12, the aperture 42(2) of the body 40(2) of the optical device 14(2) is aligned with the screw 24 on the lighting device 12. The flange diameter 46(2) is smaller than the head diameter 32 of the head 26 of the screw 24. In this manner, when the flange 44(2) is pressed against the head 26 of the screw 24, the flanges 44(2) must flex inward to allow the head 26 of the screw 24 to access the aperture 42(2). Once the flange 44(2) is passed over the head 26 of the screw 24, the flange 44(2) can flex back into its natural position and is located in the overhang areas 33 below the head 26 of the screw 24 to hold the optical device 14(2) in position on the lighting device 12, as shown in FIGS. 8 and 9.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. An optical device comprising:
a body having one or more apertures located therein configured to detachably couple the body to a lens of a lighting device having one or more attachment elements on the lens,
wherein the attachment elements each comprising a sleeve extending from a surface of the lens, wherein the one or more sleeves are configured to receive a screw therein, wherein the screw couples the lens of the lighting device to a printed circuit board or heat sink of the lighting device and the screw includes a head, the one or more sleeves each having a sleeve diameter smaller than a head diameter of the head of the screw, and each of the one or more apertures having a flange having a flange diameter smaller than the head diameter of the head of the screw;
wherein the flange is flexible to allow the one or more apertures to be snap fit over the head of the screw, and
wherein the optical device is coupled to the lens of the lighting device at least in part by the head of the screw and detachable from the lens of the lighting device without removing the screw.

2. The optical device of claim 1, wherein the optical device is a shield, a lens, a beauty ring, or a visor.

3. The optical device of claim 1, wherein the optical device is formed from a polycarbonate.

4. The optical device of claim 1, wherein the body comprises a plurality of the one or more apertures.

5. The optical device of claim 1, wherein the body comprises one or more optical elements located thereon.

6. A lighting system comprising:
a lighting device comprising one or more attachment elements on a lens of the lighting device, the attachment elements each comprising a sleeve extending from a surface of the lens, wherein the one or more sleeves are configured to receive a screw therein, wherein the screw couples the lens of the lighting device to a printed circuit board or heat sink of the lighting device and the screw includes a head, the one or more sleeves each having a sleeve diameter smaller than a head diameter of the head of the screw; and
an optical device comprising a body having one or more apertures located therein configured to detachably couple the body, to the lens of the lighting device, each of the one or more apertures, having a flange having a flange diameter smaller than the head diameter of the head of the screw; wherein the flange is flexible to allow the one or more apertures to be snap fit over the head of the screw, and wherein the optical device is coupled to the lens of the lighting device at least in part by the head of the screw and detachable from the lens of the lighting device without removing the screw.

7. The lighting system of claim 6, wherein the optical device is a shield, a lens, a beauty ring, or a visor.

8. The lighting system of claim 6, wherein the body comprises one or more optical elements located thereon.

9. The lighting system of claim 6, wherein the lighting device includes a plurality of light emitting diodes.

10. The lighting system of claim 9, wherein the body comprises one or more optical elements located thereon configured to interact with one or more of the plurality of the light emitting diodes.
